(19) United States
(12) Patent Application Publication
(10) Pub. No.: US 2014/0125498 A1
(43) Pub. Date: May 8, 2014

(54) UNIVERSAL INTERFACE FOR COMMUNICATION OF TRAFFIC SIGNAL PRIORITY BETWEEN MASS TRANSIT VEHICLES AND INTERSECTION SIGNAL CONTROLLERS FOR PRIORITY REQUEST AND CONTROL

(71) Applicant: ITERIS, INC., SANTA ANA, CA (US)

(72) Inventors: JAMES P. CURRY, SANTA ANA, CA (US); GABRIEL A. MURRILLO, SANTA ANA, CA (US); CUONG K. LA, SANTA ANA, CA (US)

(21) Appl. No.: 14/070,241

(22) Filed: Nov. 1, 2013

Related U.S. Application Data
(60) Provisional application No. 61/722,047, filed on Nov. 2, 2012.

(51) Int. Cl. G08G 1/087

(52) U.S. Cl. CPC G08G 1/087
USPC 340/906

(57) ABSTRACT

A “smart” transit signal priority and control system includes a universal interface that enables incoming signals transmitted from approaching mass transit vehicles to request priority treatment at any traffic signal. The universal interface also enables a wireless communication link between traffic signal controller equipment and approaching mass transit vehicles and supports both electrical and data interfaces to initiate transit signal priority for any type of traffic signal controller, so that any messaging protocol used by an approaching mass transit vehicle is capable of communicating with any type of controller firmware.

### CROSS-REFERENCE TO RELATED PATENT APPLICATIONS

This patent application claims priority to U.S. provisional application 61/722,047, filed on Nov. 2, 2012, the contents of which are incorporated in their entirety herein.

### FIELD OF THE INVENTION

The present invention relates to traffic signal priority and control. Specifically, the present invention relates to an interface between intersection traffic control equipment and approaching mass transit vehicles across a wireless communication network for processing priority requests in a traffic signal priority system.

### BACKGROUND OF THE INVENTION

Studies of public transportation have indicated that up to 20 percent of the time a bus is in service, it is stopped at a traffic signal. Transit signal priority (TSP) reduces this waiting time by eliminating up to one third of the time stopped for red lights at traffic signals, and does so without adversely impacting other motor vehicle traffic. TSP therefore reduces costs and improves efficiency of a public transportation infrastructure. Transit operators are therefore constantly seeking to enhance mass transit operations through the use of transit signal priority.

Existing traffic signal priority, or preemption, systems are generally concerned with assigning priority to two types of vehicles—emergency and mass transit. When determining priority, such systems recognize that emergency vehicles have a need to be certain of a green signal when activating traffic signal preemption, whereas mass transit vehicles need some leeway to make sure their schedules are adhered to, but do not necessarily need to be certain that signals will be preempted for them.

Conventional intersection controllers operate with a variety of different electrical and data interfaces, depending on such characteristics as the manufacturer and choice of firmware used. Several different types of controllers exist: Type 170, Type 2070, NEMA, etc. Therefore, it is often the case that in order for an approaching emergency or transit vehicle to initiate traffic signal preemption, messages communicated to the intersection controller must utilize protocols that match the electrical and data interfaces used by that controller. Otherwise, the approaching vehicle and the controller cannot communicate with each other.

Additionally, the issue of different communications and messaging protocols often hampers effective TSP systems. That is because different types of vehicles are configured to issue messages in various radio communications bands, and often use different types of communications media as well. For example, messages are communicated in signals using multiple radio communications bands. Furthermore, multiple requests for priority message protocols may also be communicated, so that different types of messages may also be sent, whether it is from the same or multiple vehicles.

There is a need in the field of TSP systems for integration of both electrical and data interfaces and communications and messaging protocols, so that traffic signal controllers at particular intersections work properly with approaching emergency and mass transit vehicles. There is no existing universal interface capable of ensuring that disparate communications and messaging protocols are compatible with any and all traffic signal controllers.

### BRIEF SUMMARY OF THE INVENTION

It is therefore one objective of the present invention to provide an electrical input to initiate and terminate TSP service on intersection signal controllers so that mass transit vehicles can communicate with any intersection signal controller equipment, regardless of the electrical and data interface required by a particular controller. It is another object of the present invention to provide a universal interface in a TSP system in which messages communicated in any format are compatible with any type of intersection signal controller. It is still another object of the present invention to enable a “smart” mass transit system that includes mass transit vehicles, intersection controller equipment, a centralized TSP system monitoring system, and a field computing environment comprised of components that enable mass transit vehicles to communicate with any intersection signal controller. It is still another object of the present invention to provide a universal interface for a “smart” mass transit system that is capable of installation and operation in any existing type of traffic controller housing or cabinet.

The present invention discloses a universal interface for transit priority request systems, known as TransitHelper™, between traffic controller equipment and approaching mass transit vehicles. This universal interface supports both electrical and data interfaces to initiate transit signal priority, ensuring that transit signal priority can be implemented with virtually any traffic signal controller. TransitHelper™ supports both serial and Ethernet data communications, secure wireless network interfaces utilizing, for example, the 2.4 GHz and 5.0 GHz Wi-Fi, 4.9 GHz public safety, and 5.9 GHz DSRC bands, as well as other bands and frequencies, and multiple bus-to-intersection request-for-priority message protocols to support current and enhanced transit signal priority algorithms for both schedule and headway-based transit operations. The present invention also supports data logging and reporting, including actions taken by the traffic signal controller in response to requests for priority by mass transit vehicles. The universal interface operates over a wireless communications network to facilitate communications, and serves as its own network client. TransitHelper™ is a key component of transit signal priority (TSP) systems provided to the public mass transit industry, to be deployed for bus rapid transit and other transit services by public transit operators and local traffic engineering agencies.

TransitHelper™ is a priority request server embodied in a field computing environment consisting hardware and software components that provide the universal interface between mass transit vehicles and traffic signal controllers. The universal interface receives and translates wireless communications messages initiated by approaching transit vehicles to standard data or electrical inputs to the intersection or traffic signal controller in order to provide priority treatment (for example, early green, extended green, or “green hold” (for example where a traffic signal is operating in an uncoordinated mode.) for the approaching mass transit vehicles. These hardware and software components may be housed in a traffic signal controller cabinet.

In one embodiment of the present invention, an interface for a transit signal priority system comprises a priority request server positioned proximate to and coupled to an intersection signal controller at a traffic intersection, the priority request server providing a link between data in an incoming message transmitted from an approaching mass transit vehicle and the intersection signal controller, the priority request server configured to determine a data type, a message protocol, and a message type from one or more data packets in the incoming message and translate the incoming message into an instruction comprising at least one of a standard electrical input or a data message for the intersection signal controller so that the approaching mass transit vehicle affects traffic signal operation where a priority request is within an incoming message, for any messaging protocol used to transmit the incoming message and for any firmware configuration of the intersection signal controller.

In another embodiment of the present invention, a method of interfacing data communications between approaching mass transit vehicles and intersection signal controllers comprises receiving incoming signals comprised of one or more data packets in messages initiated by mass transit vehicles approaching a section of roadway having a intersection signal controller, each incoming message indicative of a request for priority at a traffic signal at an intersection at the section of roadway; determining a data type, a messaging protocol, and a message type of the message in each incoming signal; and translating the incoming signals into instructions comprising one or more of standard electrical inputs or data messages for the intersection signal controller, the instructions permitting any messaging protocol communicating the incoming signal to instruct the intersection signal controller to request priority for the approaching transit vehicles so that traffic controller firmware accommodates any priority request communicated using any messaging protocol employed by an approaching mass transit vehicle.

In yet another embodiment of the present invention, a mass transit priority request system comprises a priority request server housed in a controller cabinet and forming a universal interface between incoming messages communicated by approaching mass transit vehicles and intersection signal controllers, the priority request server configured to translate priority requests in the incoming messages into instructions for an intersection signal controller to which the universal interface is coupled, so that the approaching mass transit vehicles communicate with any intersection signal controller type, the priority request server further comprising a wireless communications module configured to operate the universal interface as a wireless network client for communications with approaching mass transit vehicles and with the intersection signal controller to which the universal interface is coupled.

Other objects, embodiments, features and advantages of the present invention will become apparent from the following description of the embodiments, taken together with the accompanying drawings, which illustrate, by way of example, the principles of the invention.

### BRIEF DESCRIPTION OF THE SEVERAL VIEWS OF THE DRAWINGS

The accompanying drawings, which are incorporated in and constitute a part of this specification, illustrate several embodiments of the invention and together with the description, serve to explain the principles of the invention.

FIG. 1 is a block system diagram of a “smart” mass transit system according to one embodiment of the present invention;

FIG. 2 is a diagram showing functions of a universal interface in a “smart” bus system according to one embodiment of the present invention;

FIG. 3A is a logic diagram showing processing of incoming priority requests in a universal interface according to one embodiment of the present invention;

FIG. 3B is a continuation of the logic diagram of FIG. 3A showing processing of incoming priority requests in a universal according to the embodiment of FIG. 3A;

FIG. 4 is an exemplary screenshot of a dashboard and configuration tool according to another embodiment of the present invention;

FIG. 5 is another exemplary screenshot of a dashboard and configuration tool according to the embodiment of FIG. 4; and

FIG. 6 is another exemplary screenshot of a dashboard and configuration tool according to the embodiment of FIG. 4 and FIG. 5.

### DETAILED DESCRIPTION OF THE INVENTION

In the following description of the present invention reference is made to the accompanying figures which form a part thereof, and in which is shown, by way of illustration, exemplary embodiments illustrating the principles of the present invention and how it is practiced. Other embodiments will be utilized to practice the present invention and structural and functional changes will be made thereto without departing from the scope of the present invention.

The present invention is a universal interface for wireless communications between mass transit vehicles and traffic signal controllers. The universal interface is embodied at least in part in a field computing environment that includes a transit priority request server and additional hardware and software components that provide support for multiple electrical and data interfaces with any traffic signal controllers. This field computer is capable of receiving and translating wireless communications messages initiated by approaching transit vehicles to standard data or electrical inputs to traffic signal controllers in order to provide priority treatment for the approaching mass transit vehicles. Examples of such priority treatment include early green, extended green, green holds, queue jumps, skipping of signal phases, and other types of traffic signal timing adjustment.

The present invention also provides support for multiple message protocols, and multiple radio communications bands. The universal interface may be housed within existing intersection traffic signal controller cabinets or in its own housing, but regardless, is contemplated that the present invention is to be positioned in close proximity to traffic signal controller equipment. Examples of such radio communications bands include the 2.4 GHz Wi-Fi and 4.9 GHz public safety bands, and TransitHelper™ may be further configured to serve as an integrated network client for such communications. It should be noted that alternatively, components enabling TransitHelper™ to communicate may be external components to the priority request server and therefore not integrated within the present invention.

The universal interface is therefore applicable in mass transit signal priority (TSP) systems and facilitates communications between approaching mass transit vehicles and traffic signal controllers across wireless networks over which such vehicle-to-controller communications occur. The universal interface translates messages transmitted by transit vehicles into an electrical input that can be understood by any type of traffic signal controller. It is contemplated that the present invention is capable of acting as the universal interface for any type of intersection controller, so that TSP service is enabled across all types of controller firmware, including those based on proprietary standards. The priority request server of the universal interface is also capable of serving as a network client.

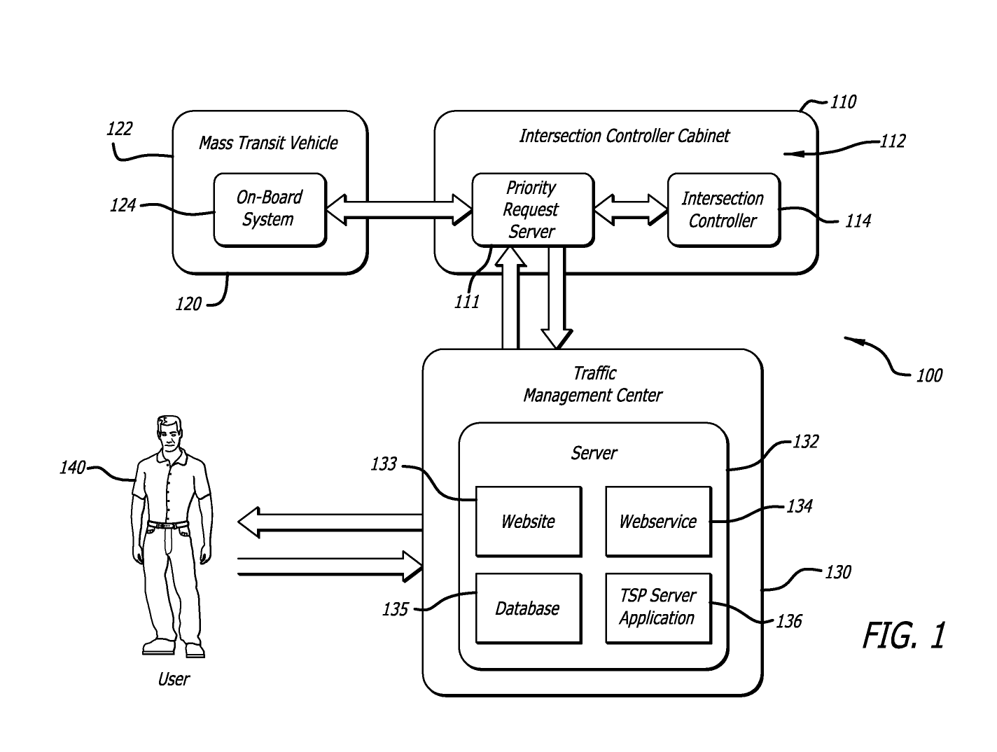

FIG. 1 is a block diagram of a “smart” mass transit system 100 that generally includes intersection signal components 110, vehicular components 120, and TSP system monitoring components 130. The intersection signal components 110 at least include a priority request server 111 and data processing logic components that together form a universal interface 112, embodied in a field computing environment that further comprises components such as processors, memory, and radio and network equipment, that collectively provide a link between the vehicular components 120 and an intersection signal controller 114. The universal interface 112 may be positioned at or near, or coupled to, the intersection signal controller 114. Vehicular components 120 include mass transit vehicles 122 and on-board systems 124. TSP system monitoring components 130 include a TSP server 132 which manages at least one website 133, a web service 134, at least one database 135, and one or more server applications 136. The TSP server 132 includes components enabling one or more users 140 to interact with the “smart” mass transit system to perform a plurality of data management functions, such as data reporting, using the one or more server applications 136. The interface 112 also includes configuration and data management tools that enable users 140 to connect with and configure the universal interface 112, as well as to view and manipulate information generated by the universal interface 112.

The universal interface 112, as noted above, provides a link that enables communication of messages between approaching mass transit vehicles 122 and intersection signal controllers 114. Components of the field computing environment such as the data processing logic are configured to at least determine a connection type, a data type, a message protocol, and a message type from one or more data packets within incoming messages from mass transit vehicles 122 and convert these messages into instructions in the form of a standard electrical input or a data message for an intersection signal controller 114, so that regardless of a traffic signal controller configuration, an approaching mass transit vehicle 122 is capable of affecting traffic signal operation with priority request messaging.

The TransitHelper™ system embodied by the present invention operates in conjunction with the existing national infrastructure for transit signal priority. The National Transportation Communications for ITS Protocol (NTCIP) Standard 1211 has created a framework for the deployment of systems to enable priority treatment for mass transit vehicles 122 at signalized intersections. As part of the standard, NTCIP 1211 defines the overall functionality of a transit priority request server and/or other devices or components that serves as the interface between communications initiated by mass transit vehicles 122 and the intersection traffic signal equipment.

The present invention meets the requirements of NTCIP 1211 for a priority request server and extends beyond the requirements set forth in NTCIP 1211 by providing support for both standard electrical and data interfaces to initiate transit signal priority, ensuring that transit signal priority can be implemented with virtually any traffic signal controller. The universal interface of the present invention converts the incoming message into a standard electrical and data input that can be recognized by any firmware in any intersection signal controller 114 for traffic signals. The present invention also provides support for multiple bus-to-intersection request for priority message protocols to support current and enhanced transit signal priority algorithms for both schedule and headway based bus operations, and support for secure wireless network interfaces utilizing at least the 2.4 GHz or 5.0 GHz Wi-Fi or 4.9 GHz public safety bands (and other bands and frequencies), thereby serving as network client for communications on supported bands.

The interface 112 and priority request server 111 of the present invention therefore include many characteristic functions that enable vehicle-to-controller communications in a “smart” mass transit system 100. As noted above, one such function is to provide an electrical input to initiate and terminate TSP service on intersection signal controllers 114 so that mass transit vehicles can communicate with any intersection signal controller 114 regardless of the electrical interface required by a particular controller. The present invention is therefore configured to provide required electrical inputs for intersection signal controllers 114 using a Type-170 or a Type-2070 electrical interface, such as for example Type 170 and Type 2070 intersection signal controllers 114. Other intersection signal controllers 114 have specific requirements, such as those employing a NEMA interface, and the present invention is therefore also configured to provide a single pulse on check-in and checkout pins to initiate and terminate TSP service for example on NEMA T2 controllers.

The present invention may also provide a serial data interface to initiate and terminate TSP service, such as for example on Type-170 controllers running B1 Tran 233 or LACO-4E firmware and Econolite ASC/2 or ASC/3 controllers. The present invention may additionally provide an IP data interface to initiate and terminate TSP service using an internet protocol-based data input, for example as required with some Type-2070 controllers, and other protocols such as NTCIP compliant Simple Network Management Protocol (SNMP) data interfaces. In these embodiments, the present invention may serve as a replacement for a terminal server and network client, with additional data management functionality. Regardless, it is to be understood that the present invention acts as a universal interface 112 between mass transit vehicles 122 and any intersection signal controller 114 regardless of its type or firmware configuration, and accordingly provides flexibility to easily accommodate revised message protocols for additional data formats or formats that are developed.

As noted herein, the universal interface 112 may serve as a wireless network client. The present invention therefore includes components enabling the universal interface 112 to function as for example an IEEE 802.11b/g network client, and capable of being integrated as part of a WLAN of a TSP system monitoring components 130. The present invention also supports TSP WLAN requirements, including WPA and WPA2 security protocols. It further supports Simple Network Management Protocol (SNMP) remote monitoring.

The universal interface 112 is configured to receive check-in, position update, and checkout messages 210 that request priority transmitted from mass transit vehicles 122, using any messaging protocol as discussed herein. The universal interface 112 is also configured to automatically verify the incoming message 210 and determine which messaging protocol is being utilized, and then to initiate either an appropriate electrical input or a data message as an instruction for an intersection signal controller 114 when a valid check-in or position update message requesting priority is received. The universal interface 112 is further configured to terminate an electrical input to an intersection signal controller 114 when a valid checkout message is received, or when a priority request 211 times out. Termination of a priority request 211 may also occur where there are near-side stops at an intersection at which the present invention is located.

The universal interface 112 includes data logic components that are configured so that various data management functions can be performed, such as for example comparing actual headway with scheduled headway to determine whether to request priority based on a difference between the two. A threshold difference may be utilized in such a determination, and this threshold difference may be a user-specified parameter. The universal interface 112 may also include other capabilities, such as for example maintaining a table by mass transit vehicle line number and direction of actual headways being operated, verifying an intersection identifier for received messages 210, and logging time-stamped messages 210 received from mass transit vehicles 122.

The data logic components may also be configured to determine and update position information for mass transit vehicles 122. For example, the universal interface 112 may determine a latitude and longitude of a mass transit vehicle 122, and estimate and track a vehicle location for check-in and position update messages. This information may be provided, for example, where a mass transit system 100 includes arrival time signage.

The universal interface 112 may be further configured to apply specific decision-making rules based on operational data, user-specified instruction, or intersection-specific requirements to determine if priority will be requested. For example, the present invention may be configured to determine priority while taking into account whether a mass transit vehicle 122 is late, how many passengers it has, whether it is currently a rush-hour time of day, and what type of line is being operated (such as an express line). Operational data may be historic data or may be learned by one or more neural networks or other logic-based learning system of determining whether priority should be granted.

The present invention may further include the ability to determine an action taken by controller firmware, where supported by software installed at intersection signal controllers 114 to which the universal interface 112 is coupled. For example, the universal interface 112 may log where a priority request 211 in an electrical input provided to the intersection signal controller 114 is rejected. This may occur, for further example, where an invalid intersection identifier is included in the priority request 211, or where priority is rejected due to the difference between actual headway and scheduled headway is greater than the user-specified threshold difference parameter.

The universal interface 112 is also capable of uploading messages 210 to the TSP system monitoring components 130, such as the TSP server 132, for example using a TSP WLAN. Messages uploaded may include the action taken on a priority request 211 and a time-stamp, and may be uploaded either in real-time or upon request from a server application 136. The universal interface 112 may therefore include database management and reporting tools for providing information to TSP system monitoring components 130.

The universal interface 112 may be further configured to support controller firmware that limits priority based on a number of seconds or cycles, such as a cycle relative to a time of day, and therefore at least reporting tools in the universal interface 112 may take into account priority-limiting activity in actions taken that are included with reported messages. The data logic components may be further configured so that, where supported by the messaging protocol, a priority decision can be made where there are two or more mass transit vehicles 122 at the same time. The data logic components are configured to determine, from different factors relative at least to one or more of actual headway, scheduled headway, user-specified parameters, and controller firmware specifications, a multi-vehicle at the same time situation, and how to assign priority in such a situation. Logic components may be either implemented as part of the priority request server 111 or implemented in conjunction with intersection controller components 114.

It should be understood that the present invention is further capable of receiving and logging priority requests 211 without initiating electrical inputs to intersection signal controllers 114. This may be done for example in intersection signal controller 114 or TSP WLAN testing situations. The present invention is also capable of providing a map-based display for graphical user interfaces, as noted below, which may show priority requests 211 and actions taken, for both real-time and historical data.

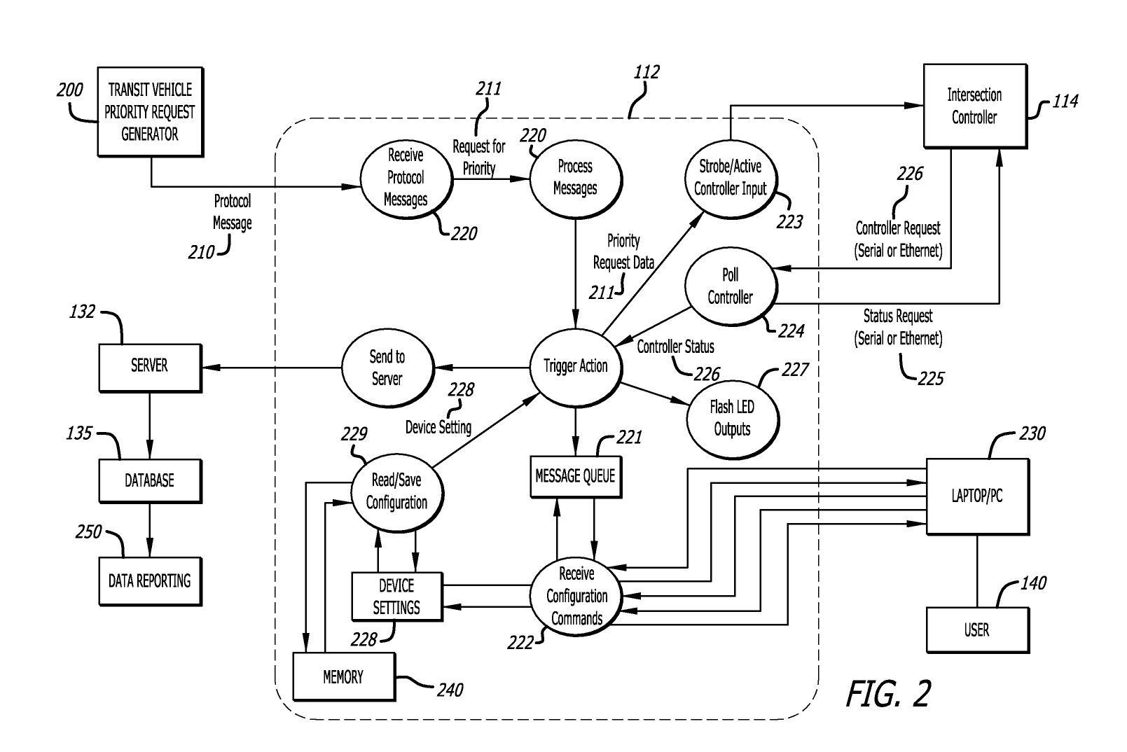

FIG. 2 is a block diagram showing functions of the universal interface 112 in a “smart” bus system 100 according to one aspect of the present invention. The vehicular components 120 include a transit vehicle priority request generator 200 positioned at a mass transit vehicle 122 that generates signals containing protocol messages 210. These protocol messages 210 contain data packets that include priority requests 211 and may be further indicative of various characteristics of the mass transit vehicle 122. The present invention contemplates that a message 210 may be communicated in any format, since the priority request server 111 is capable of receiving messages 210 and translating the data therein to ensure compatibility with electrical and data interfaces with virtually any type of intersection signal controller 114. According, protocol messages 210 may be communicated using a proprietary standard messaging format, messaging formats specific to a customer's system, or one or more common or standard messaging formats, and it is to be understood the present invention is not to be limited to any one type of messaging format.

The priority request server 111 is configured to receive incoming protocol messages 210 from the transit vehicle priority request generator 200. The universal interface 112 is comprised of hardware and software components to process the incoming protocol messages 210 and trigger a plurality of actions, such as communicating with hardware of an intersection signal controller 114 to send priority request data 211, communicate messages to and from user-operated systems, and communicate with one or more servers and databases to report priority requests 211 and the actions taken.

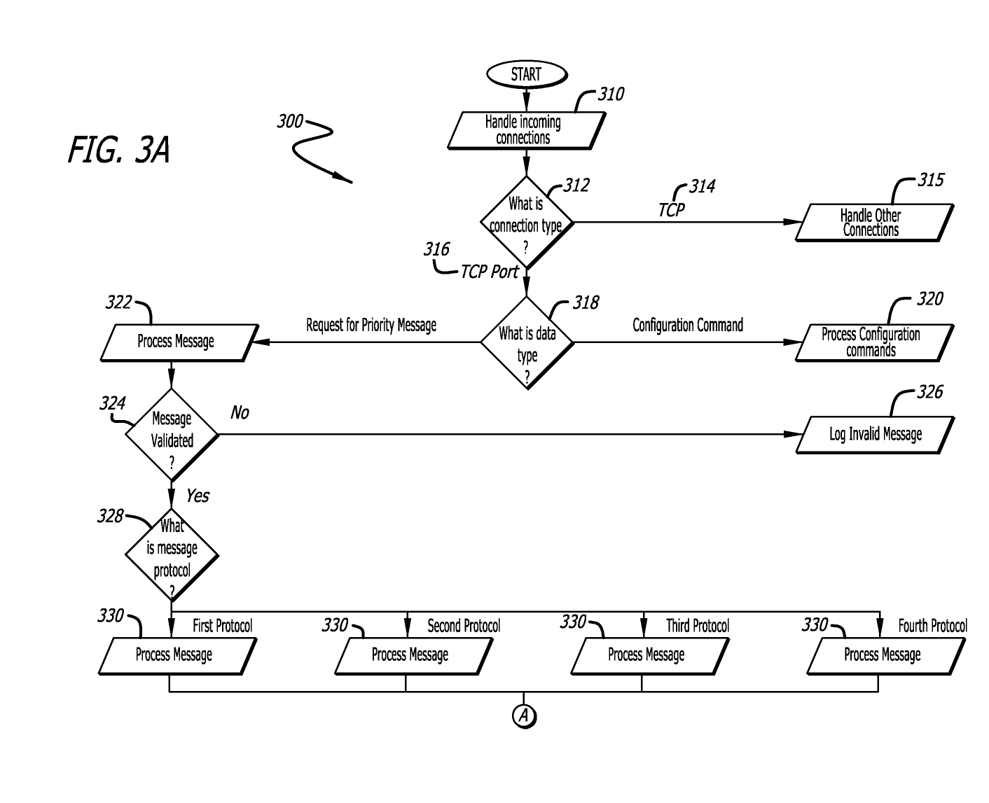

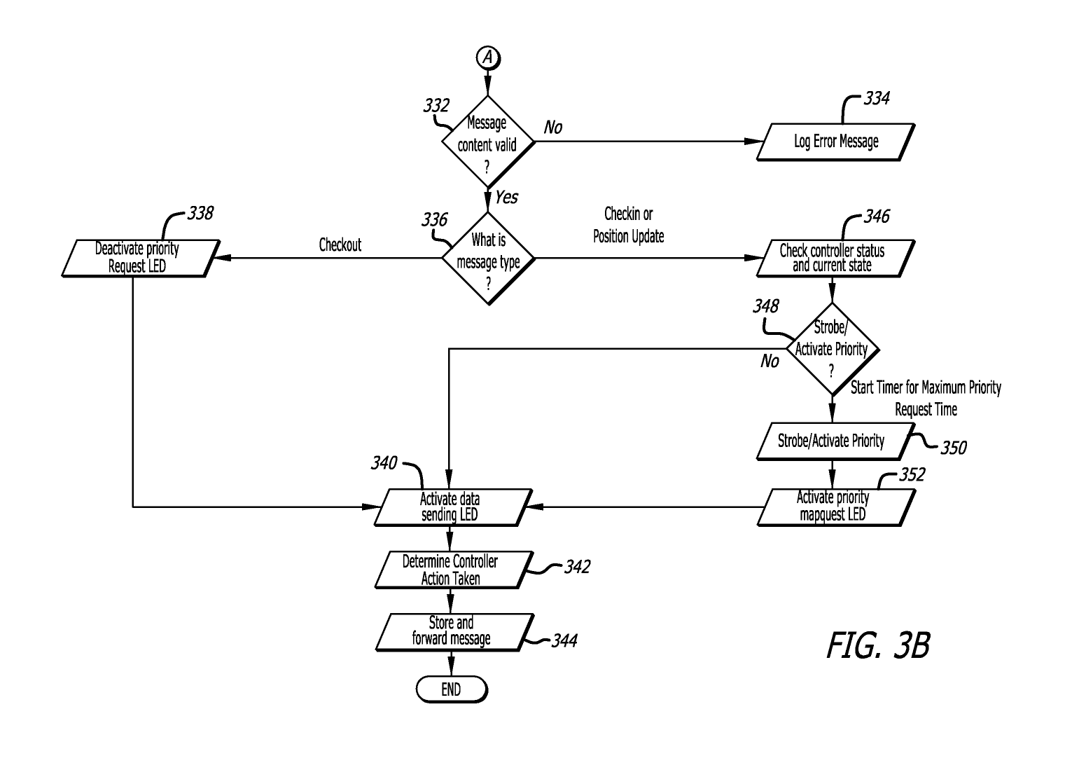

The priority request server 111 of the universal interface 112 processes and translates incoming messages 210 for the intersection signal controller 114 according to the framework of FIG. 3A and FIG. 3B. Incoming wireless signals may be translated into data input containing priority requests 211 in messages 210 for appropriate intersection signal controllers 114 using serial or Ethernet communications. The priority request server 111 receives and verifies content of one or more priority requests 211, which are initiated and transmitted by mass transit vehicles 122 approaching an intersection with a traffic signal. The universal interface 112 may include a Transit Route Wireless Local Area Network (Transit Route WLAN) which serves as a communication platform over which reporting of these messages 210 are transmitted to the TSP server 220. As noted herein, the universal interface 112 therefore also functions as a wireless network client in accordance with IEEE 802.11 standards and is able to be integrated as part of the Transit Route WLAN for operation on 2.4 GHz Wi-Fi band, the 4.9 GHz public safety band, or any other band or frequency over which communications may occur.

Messages 210 may include many different types of priority requests 211 as noted above. The universal interface 112 supports conditional or always-on priority for mass transit vehicles 122, as well as transit signal priority for both schedule-based and headway-based Bus Rapid Transit (BRT) operations. The present invention is also capable of maintaining tables of actual headways by direction, where conditional priority is based on ahead/behind scheduled headway for headway-based BRT operations. The universal interface 112 also supports blocking back-to-back priority requests 211 according to user-specified minimum time to aid in the smooth and effective flow of traffic at an intersection. Each of these functions may be customizable by users 140 of the universal interface 112, so that for example, the user-specified minimum time is customizable.

The present invention is designed for installation and operation in any existing type of traffic controller housing or cabinet, such as for example the Type 332 and National Electrical Manufacturers Association (NEMA) traffic controller cabinets. Importantly, as noted throughout, the present invention is compatible with any type of signal controller hardware or firmware. This allows for seamless processing of priority requests 211 from incoming wireless signals transmitted by approaching mass transit vehicles 112 and ensures that these priority requests 211 will be addressed, regardless of the equipment in use at any given traffic intersection.

This seamless processing of priority requests 211 is accomplished by translating the incoming wireless signal, and the data messages contained therein, into either pulsed electrical inputs to initiate and terminate transit signal priority (TSP) service with Type 170 and Type 2070 controllers, or by providing electrical inputs as a single pulse on check-in and checkout pins to initiate and terminate TSP service on NEMA traffic controllers, as discussed further herein. The present invention therefore determines the type of traffic signal controller to which it is coupled, and translates the incoming wireless signal according, providing the proper electrical or data input as required.

The present invention contemplates that the universal interface 112 also operates with traffic signal priority and preemption systems used by emergency vehicles. It is further contemplated that the universal interface 112 functions seamlessly alongside commercially-available Emergency Vehicle Pre-emption (EVP) systems running in the same traffic signal controller cabinet.

Continuing with FIG. 2, the present invention receives the priority requests in protocol messages 210 from a transit vehicle priority request generator 210 and processes data within those messages 210 to trigger a plurality of functions 220. Messages are placed in a message queue 221 and the universal interface 112 applies configuration commands 222 to messages 210 that are received, for example, from a user 140 via a computing device 230 such as a laptop, as shown in FIG. 2.

The universal interface 112 communicates priority request data to toggle 223 an intersection signal controller 114 by providing electrical input to hardware of an intersection signal controller 114. The present invention also polls 224 the hardware of the intersection signal controller 114, by sending controller status requests 225 and receiving status data 226 in return from the intersection signal controller 114. The universal interface 112 may also send data to toggle LEDs outputs 227 on system hardware within the field computing environment.

As noted above, one or more users 140 are capable of accessing the universal interface 112 using a computing device 230, whether it be a desktop, laptop, tablet, or notebook computer, or another mobile device such as data-enable telephone. The computing device 230 may be enabled with a configuration tool as discussed further herein, and regardless, the user may utilize the computing device 230 to configure the universal interface 112 by adjusting settings 228 and otherwise sending and receive commands and messages 210. The present invention therefore includes specific components to manage system activity such as messaging with a remote configuration system that enables queuing of messages and communication of information in the universal interface 112 to ensure proper processing of priority requests. The universal interface 112 further includes the function of reading and saving configuration information 229 relative to settings 228, which may be read and stored with memory components such as a memory card 240.

As noted above, the present invention is a component of a “smart” transit system 100 that includes at least one TSP server 132 of the TSP system monitoring components 130. When messages 210 requesting priority are communicated and acted upon by the universal interface 112, the message 210, together with the action taken, is communicated to the TSP server 132 over Ethernet or wireless networking, and the message 210 and data representing actions taken in response thereto may be stored in a database 135 coupled to the TSP server 132.

The present invention also supports determination and reporting of actions taken by the intersection signal controller 114, where such functions are supported by software within the intersection signal controller 114 itself. The universal interface 112 is capable of compiling logs of messages 210 received from mass transit vehicles 122, including time-stamping of each message 210. The universal interface 112 may be configured to upload priority requests 211 in messages 210 received from mass transit vehicles 122 with the time stamp added, and intersection signal controller 114 action taken, to the TSP server 132. These priority requests 211 may be uploaded in real time to the TSP server 132, or may be uploaded upon request from a TSP server application 136 responsible for executing such data management tasks. Among the data management tasks performed by TSP server applications 136 are data reporting 250.

FIG. 3A and FIG. 3B are a logic diagram showing processing steps 300 of incoming priority requests 211 in messages 210, and translating such priority requests 211 into appropriate electrical inputs for the intersection signal controller 114 to which the universal interface 112 is communicatively coupled. In FIG. 2, the present invention initiates a process of handling incoming connections 310 by first determining an Internet protocol connection type 312 that is being utilized by the incoming data transmission. For example, certain connections 314 are handled differently from Transmission Control Protocol (TCP) connections 316. For such other connections 314, the present invention may be configured to call a separate logic library for processing priority requests 211 and therefore messages 210 communicated by different connection types are handled according to different logic functions. For messages 210 following a TCP/IP protocol, the present invention initially determines a data type 318, i.e. whether the incoming message 210 is a configuration command communicated by a user of the universal interface 112, or whether it is a priority request 211 in a message 210 from an approaching mass transit vehicle 122. Configuration commands are processed 320 by a configuration module.

Once the universal interface 112 confirms an incoming TCP connection 316 in which an incoming message 210 includes a priority request 211, processing 322 of the data packets comprising the message 210 begins. Processing 322 includes verifying content of messages 210 and, where provided, application of user-specified decision making rules to determine how priority requests 211 will be evaluated. The present invention therefore searches and applies any user-specified or other operational-specific rules, such as for example what type of line a mass transit vehicle 122 is operating, how many passengers are being transported, etc. The present invention therefore contemplates that users 140 may specify specific rules for determining when priority requests 211 are approved or denied, and logic components are to apply these rules when processing 322 incoming messages 210.

The present invention applies logic to validate the message 210 format and content beginning at step 324. If no such validation occurs, an error message module is called to log 326 the error message. If there is a validation, the present invention next determines what type 328 of message protocol 210 has been received.

As noted above, many different message protocols are contemplated, and the present invention is not intended to be limited to any one such messaging protocol. Messaging protocols may therefore include industry-wide standards or system-specific protocols. For example, possible messaging protocols within Los Angeles County and/or Southern California may include LACMTA pilot protocol and LACMTA Metro Rapid protocol, as well as other standard and/or proprietary protocols. This flexibility enables the present invention to easily accommodate revised or expanded message protocols, for future or enhanced messaging in which additional data elements or formats are required. The present invention initiates processing the messaging protocol received at step 330 according to its specific format.

Once the present invention determines the messaging protocol at step 328 and processes the specific messaging protocol at step 330, it then confirms whether the message content is valid at step 332. If it is not valid, the error message is logged at step 334. If it is valid, the present invention then determines the message type at step 336. The message type is either a checkout or checkin or position update. If the message is a checkout indicating the end of a priority request 211, the universal interface 112 deactivates the priority request LED at step 338, activates the data sending LED at step 340, and determines the controller action to be taken at step 342. The present invention then stores the message with the controller action and forwards the message at step 344. This may occur in the form of bytes that indicate a status after the universal interface 112 issues a request to a controller to activate priority.

If the message is a checkin or position update, the present invention checks the controller status and the current system state at step 346. A thread runs concurrently with other processes in the system that polls the intersection signal controller 114 periodically for its current status. The controller's current status and device state determine if it should activate or not to accept the priority request 211 at step 348. For example, if the controller is currently in priority or if there is an inhibitor active (such as an instruction not to activate until after 5 minutes), then the universal interface 112 will not initiate priority. If it is determined that the universal interface 112 does initiate at step 350, the priority request LED will be activated at step 352. The present invention then determines the controller action to be taken at step 342, and stores and forwards the message with the controller action at step 344.

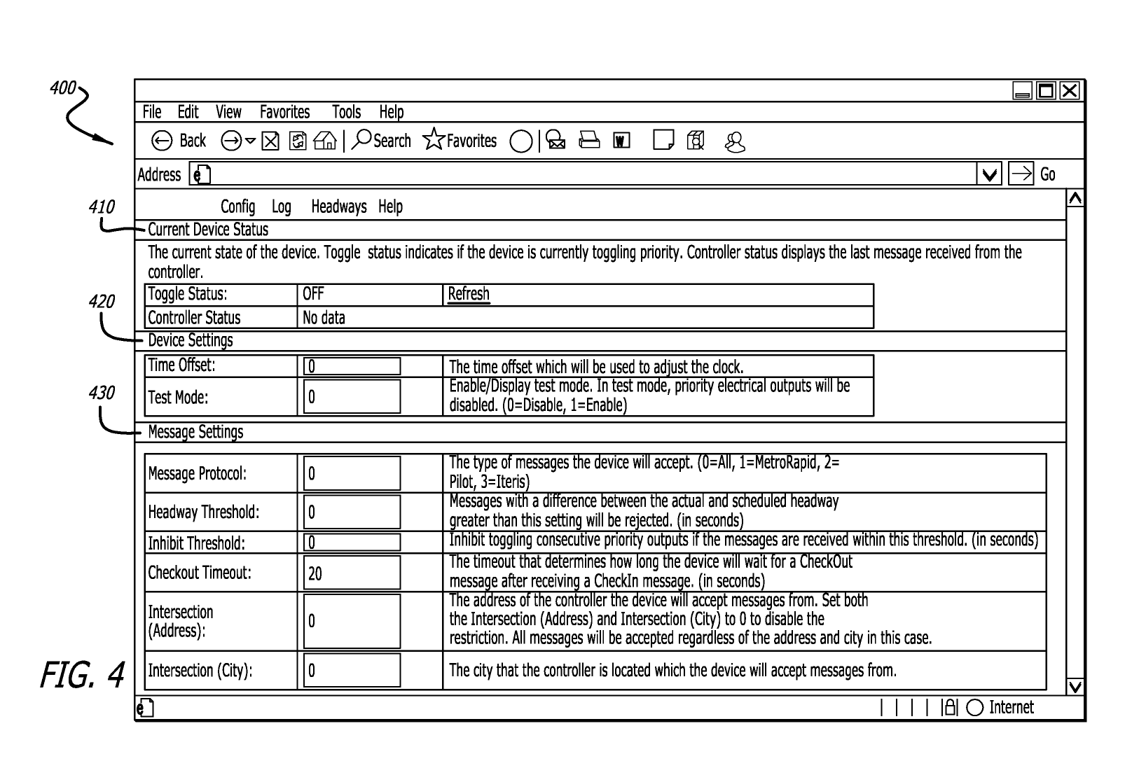

As shown in FIGS. 4-6, the present invention includes, in an additional embodiment, a dashboard and configuration tool 400 that allows for users to remotely access and configure various system settings of the universal interface 112. Remote access is contemplated via a direct connection or through a secure Wi-Fi connection using, for example, a WLAN such as the Transit Route (TSP) WLAN. Users accessing the universal interface 112 of the present invention may do so using a laptop computer or other mobile computing and/or telephony device comprising device 230. The network client aspect of the present invention may also be configured by remote access by a user 140 using the WLAN or by direct connection to computing device 230.

FIG. 4 shows an exemplary screenshot of one aspect of the dashboard and configuration tool 400. The screenshot of FIG. 4 shows a “Config” screen with a current status section 410 of the universal interface 112. It displays a “Toggle Status” section to show whether the universal interface 112 is currently toggling priority, and a “Controller Status” section to display the last message received from the intersection signal controller 114. The “Config” screen includes a Device/Interface Settings section 420, and provides the user 140 with the ability to adjust at least a time offset and test mode. A Message Settings section 430 allows the user 140 to customize a plurality of settings related to the messages 210 received from approaching mass transit vehicles 122. Users 140 may instruct the universal interface 112 on the type of messages 210 the present invention will accept (such as for example “All”, or “Metro Rapid”). Users 140 may also adjust a headway threshold, which relates to adjusting the rejection threshold, in seconds, for the difference in messages 210 between the actual and scheduled headway. An “Inhibit Threshold” sets the time, in seconds, for inhibiting toggling of consecutive prior outputs for messages 210 received within the threshold.

Additional indicia displayed in this Message Settings section 430 in the “Config” screen of the dashboard and configuration tool 400 at least include a “Checkout Timeout” and different “Intersection” settings, for both “Address” and “City”. The “Checkout Timeout” setting determines how long the system will wait for a “Checkout” message after receiving a “Checkin” message, in seconds. The “Intersection (Address)” setting allows customization of the address of the intersection signal controller 114 the present invention will accept messages 210 from, and the “Intersection (City)” setting allows the user to determine the city in which the intersection signal controller 114 is located which the present invention will accept messages 210 from.

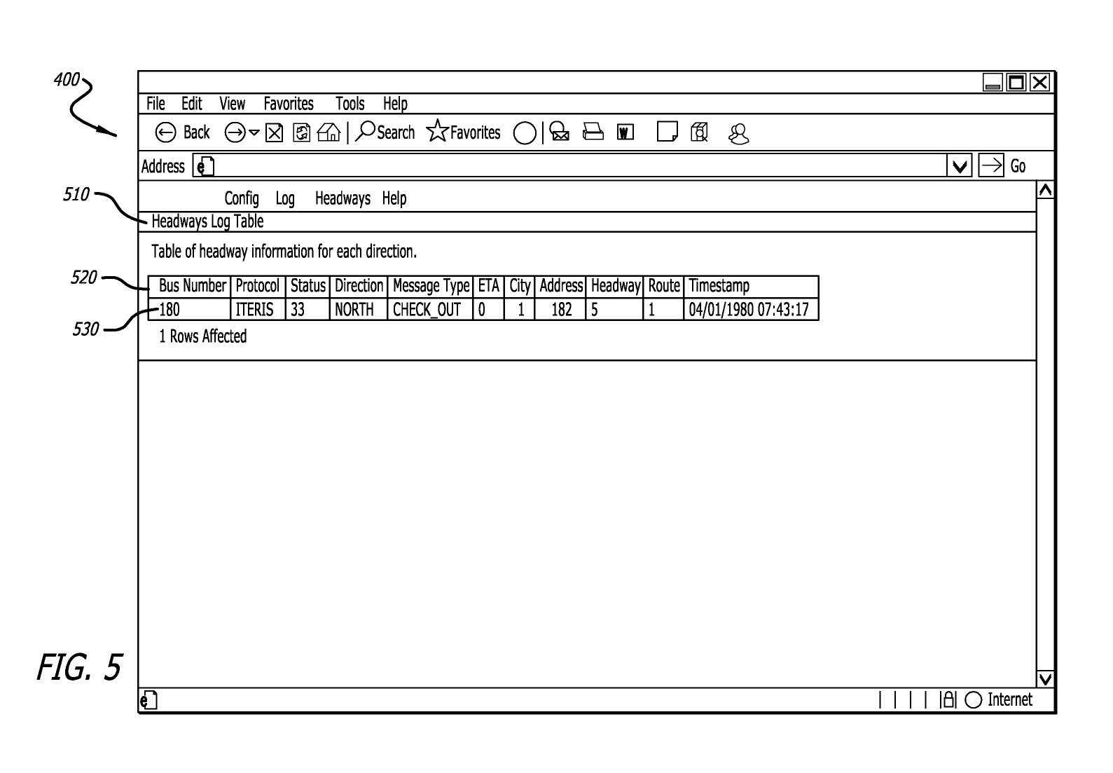

The dashboard and configuration tool 400 may also include a “Headway” screen displaying a “Headway Log Table” section 510, as shown in FIG. 5. This section 510 displays to the user 140 a table 520 of headway information 530 for each direction. Headway information 530 may include the transit vehicle number, the message protocol, a status of the message, the direction, the message type (Checkout or Checkin), an estimate time of arrival (ETA), the city and address information, the headway number, the route, and a timestamp. This headway information 530 therefore allows the user 140 to view system data by specific headway, or direction.

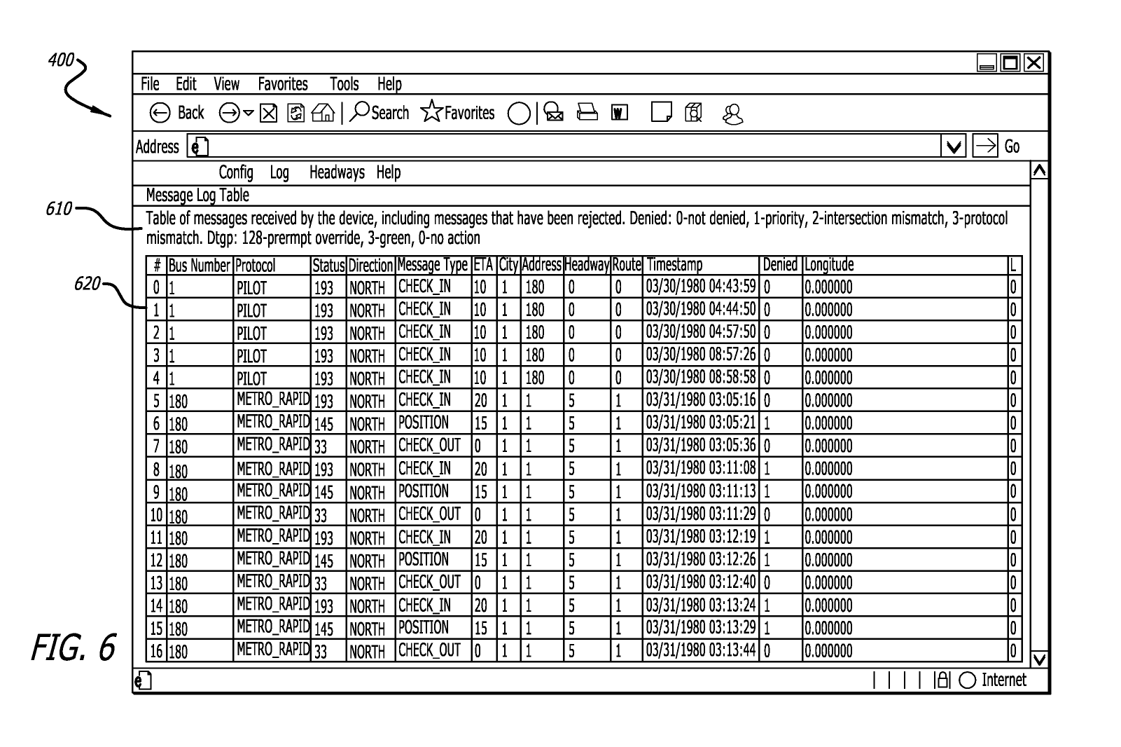

The dashboard and configuration tool 400 may also include a “Message Log Table” section 610, of which an example is shown in FIG. 6. This “Message Log Table” section 610 provides the user 140 with a table 620 of all messages 210 received by the present invention, including rejected messages 210. This message log table 620 may display the same information as that shown in the “Headways” table 520—the transit vehicle number, the message protocol, a status of the message, the direction, the message type (Checkout or Checkin), an ETA, the city and address information, the headway number, the route, and a timestamp. The table 620 of the “Message Log Table” section 610 may also show additional data, such as whether a priority request has been granted or denied, and positional information such as longitude and latitude.

The dashboard and configuration tool 400 may also include a “Help” screen which provides the user with further information about what data the “Config”, “Message Log Table”, and “Headway Log Table” sections provide.

The present invention may also include a dashboard-style presentation of system data available to a user 140 accessing the system from a remote computer or device according to another embodiment of the present invention. The dashboard and configuration tool 400 visually presents system data in a graphical user interface, and may be accessible via a web page from any remote computing or telephony device 230.

The dashboard-style presentation of information allows users 140 to view different routes and directions in an animated map. The different routes are selectable from a pull-down menu, as are directional selections. The animated map may be customized to display priority requests visually in a number of different ways, and is capable of being adjusted so that users can zoom in and out of each map. A separate area of the dashboard-style presentation in the tool allows users 140 to view real-time priority requests 211. Other pull-down menus or links offer additional functions to the users 140, such as a help function and a logout function. Other functions may also be available, such as widget-style presentations of data that are selectable, customizable, and movable by the user 140.

The present invention meets applicable electrical and environmental standards for installation in intersection controller cabinets. In one embodiment, it is contemplated that the transit priority request server 111 and other hardware and software components comprising the universal interface 112 are to be housed in a NEMA-rated enclosure with brackets for rail mounting, and made of an appropriate material such as aluminum or steel. It is to be understood, however, that any type of housing and mounting may be used that permits a sufficient connection to an intersection signal controller 114 and that ensures system integrity, reliability, and durability.

The present invention is performed, as noted herein, in a field computing environment comprised of multiple hardware, software, and firmware components that are configured to execute a plurality of instructions in one or more memory-based modules to translate incoming messages containing priority requests using any existing messaging protocol into standardized electrical inputs for any traffic signal intersection equipment.

The multiple hardware, software, and firmware components comprising the field computing environment described herein are capable of installation and operation in any existing type of traffic controller housing or cabinet, and intended for localized use at or near places where traffic controller equipment is positioned. Each such component in the field computing environment according to the present invention is further capable of communication using wireless or Ethernet networks and with multiple information resources, and includes components capable of enabling such communications.

The present invention may be implemented in conjunction with many different hardware components, such as a special purpose computer, a programmed microprocessor or microcontroller and peripheral integrated circuit element(s), an ASIC or other integrated circuit, a digital signal processor, electronic and/or digital logic circuitry, a programmable logic device or gate array such as a PLD, PLA, FPGA, PAL, and any other comparable components. In general, any means of implementing the systems and methods illustrated herein may be used to implement the various embodiments and aspects of the present invention. Examples of devices that can be used for the present invention includes computers, handheld devices, telephony-enabled devices (e.g., cellular, Internet enabled, digital, analog, hybrids, and others), and other such hardware components, machines, and apparatuses. These may include processors (e.g., a single or multiple microprocessors), memory, nonvolatile storage, and other peripheral input devices, and output devices. Furthermore, alternative software implementations including, but not limited to, neural networks, distributed processing, parallel processing, or virtual machine processing can also be configured to perform the methods described herein.

The systems and methods of the present invention may also be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on personal computer, as a resource residing on a server or computer workstation, as a routine embedded in a dedicated measurement system, system component, or the like. The system can also be implemented by physically incorporating the system and/or method into a software and/or hardware system.

Additionally, the data processing functions disclosed herein may be performed by one or more program instructions stored in or executed by such memory, and further may be performed, as noted above, by one or more modules configured to carry out those program instructions. Modules are intended to refer to any known or later developed hardware, software, firmware, artificial intelligence, fuzzy logic, expert system or combination of hardware and software that is capable of performing the data processing functionality described herein.

It is to be understood that other embodiments will be utilized and structural and functional changes will be made without departing from the scope of the present invention. The foregoing descriptions of embodiments of the present invention have been presented for the purposes of illustration and description. It is not intended to be exhaustive or to limit the invention to the precise forms disclosed. Accordingly, many modifications and variations are possible in light of the above teachings. It is therefore intended that the scope of the invention be limited not by this detailed description.

1. An interface for a transit signal priority system, comprising
a priority request server positioned proximate to and coupled to an intersection signal controller at a traffic intersection, the priority request server providing a link between data in an incoming message transmitted from an approaching mass transit vehicle and the intersection signal controller, the priority request server configured to determine a data type, a message protocol, and a message type from one or more data packets in the incoming message and translate the incoming message into an instruction comprising at least one of a standard electrical input or a data message for the intersection signal controller so that the approaching mass transit vehicle affects traffic signal operation where a priority request is within an incoming message, for any messaging protocol used to transmit the incoming message and for any firmware configuration of the intersection signal controller.

2. The interface of claim 1, wherein the instruction requests priority at the intersection signal controller for the approaching mass transit vehicle by adjusting a timing of a traffic signal coupled to the intersection signal controller.

3. The interface of claim 2, wherein the instruction requests priority at the intersection signal controller based on an evaluation of at least one of operational and decision-making parameters.

4. The interface of claim 2, wherein the instruction requests priority to the intersection signal controller when actual headway differs with scheduled headway in excess of a user-specified value.

5. The interface of claim 2, wherein the instruction is a data message that initiates a controller status request from the intersection signal controller.

6. The interface of claim 1, the data type indicating is one of a priority request and a configuration command.

7. The interface of claim 1, wherein the message type is one of a checkin or position update and a checkout.

8. The interface of claim 1, wherein a checkin or position update initiates a controller status function and a priority request.

9. The interface of claim 1, further comprising wireless data communications components configured to enable wireless reception of incoming messages from approaching mass transit vehicles and wireless transmission of priority request information and controller status information to a centralized traffic signal priority data management system.

10. A method of interfacing data communications between approaching mass transit vehicles and intersection signal controllers, comprising:
receiving incoming signals comprised of one or more data packets in messages initiated by mass transit vehicles approaching a section of roadway having a intersection signal controller, each incoming message indicative of a request for priority at a traffic signal at an intersection at the section of roadway;
determining a data type, a messaging protocol, and a message type of the message in each incoming signal; and
translating the incoming signals into instructions comprising one or more of standard electrical inputs or data messages for the intersection signal controller, the instructions permitting any messaging protocol communicating the incoming signal to instruct the intersection signal controller to request priority for the approaching transit vehicles so that traffic controller firmware accommodates any priority request communicated using any messaging protocol employed by an approaching mass transit vehicle.

11. The method of claim 10, further comprising determining whether the message type is a checkin or position update or a checkout.

12. The method of claim 11, further comprising sending the intersection signal controller instructions when a checkin or position update indicates a priority request in the message, the instructions configured to accord priority at the intersection signal controller for the approaching mass transit vehicle by adjusting a timing of the traffic signal coupled to the intersection signal controller.

13. The method of claim 10, wherein the translating the incoming signals into instructions further comprises requests evaluating at least one of operational and decision-making parameters to request priority at the intersection signal controller.

14. The method of claim 12, further comprising determining an actual headway of the approaching mass transit vehicle and comparing the actual headway with a headway table that includes scheduled headway values, and communicating a priority request to the intersection signal controller when actual headway differs with scheduled headway in excess of a user-specified value.

15. The method of claim 12, further comprising polling the intersection signal controller for a status request with a poll function initiated by the instructions.

16. The method of claim 10, further comprising determining whether the data type indicating is a priority request or a configuration command.

17. The interface of claim 16, wherein a configuration command initiates a function configured to receive configuration commands from a user using a remote computing device.

18. A mass transit priority request system comprising:
a priority request server housed in a controller cabinet and forming a universal interface between incoming messages communicated by approaching mass transit vehicles and intersection signal controllers, the priority request server configured to translate priority requests in the incoming messages into instructions for an intersection signal controller to which the universal interface is coupled, so that the approaching mass transit vehicles communicate with any intersection signal controller type, the priority request server further comprising a wireless communications module configured to operate the universal interface as a wireless network client for communications with approaching mass transit vehicles and with the intersection signal controller to which the universal interface is coupled.

19. The system of claim 18, wherein an approaching mass transit vehicle includes a transit vehicle priority request generator in an on-board system configured to issue priority requests at traffic intersections.

20. The system of claim 18, wherein the wireless communications module is configured to report data from incoming messages and actions taken by intersection signal controllers to a centralized transit signal priority data management center, the centralized transit signal priority data management center at least including a web site, a database, a server, and a server application.

21. The system of claim 18, wherein the priority request server further includes a plurality of data processing modules configured to perform at least communication of the instructions, a polling function, and configuration function.

22. The system of claim 18, wherein the communication of the instructions and the polling function are triggered when an incoming message includes a message type comprised of a checkin or position update type, the instructions configured to request priority at the intersection signal controller for the approaching mass transit vehicle by adjusting a timing of a traffic signal coupled to the intersection signal controller.

23. The system of claim 18, wherein the priority request server evaluates at least one of operational and decision-making parameters to determine whether to request priority at the intersection signal controller.

24. The system of claim 22, wherein the instructions communicate a priority request where the intersection signal controller when actual headway differs with scheduled headway in excess of a user-specified value.

25. The system of claim 21, wherein the polling function is configured to initiate a controller status request from the intersection signal controller.

26. The system of claim 21, wherein the configuration function is triggered where a content of an incoming message is a configuration command, the configuration function enable a user to configure the universal interface using a remote computing device.
